(19) United States
(12) Patent Application Publication
(10) Pub. No.: US 2012/0155096 A1
(43) Pub. Date: Jun. 21, 2012

(54) LED Light Brick Attachment Device

(76) Inventors: Roger S. Williams, Jacksonville, FL (US); Daniel Bell, Jacksonville, FL (US)

(21) Appl. No.: 12/973,840

(22) Filed: Dec. 20, 2010

(51) Int. Cl. F21V 21/088

(52) U.S. Cl. 362/396

(57) ABSTRACT

A LED light brick attachment device comprising a U-shaped channel and one or more generally J-shaped clips, the combination of which is capable of attaching a standard LED light brick to a support structure. The channel is defined by a base and two vertical sides, forming a trough capable of slideably seating a flange of a standard LED light brick. The clip is defined by a base, a first stem, and an elongated second stem, the base, first stem, and an elongated second stem forming a J-shaped cross-section having a trough. The top of the first stem has an inwardly protruding retaining lip. The second stem has an engagement means capable of engaging a fastener on the light brick. The trough of the clip is capable of being snugly disposed about the channel such that the retaining lip of the first vertical stem is snugly disposed above to the top of one of the vertical sides of the channel, which prevents the channel from being dislodged from the clip.

### BACKGROUND OF THE INVENTION

The present invention relates generally to elongate lighting devices, and more specifically to attachment devices for extended lengths of light emitting diodes (“LED”). LED lighting is commercially available in prefabricated, rigid units or clusters, often called “LED light bricks.” Each brick, which is typically made of plastic, can comprise multiple LED lights. The light bricks can be arranged as desired to solve a wide variety of lighting problems. For example, it is known to use LED light bricks in landscape or accent lighting, security lighting, storefront signage, and emergency exit illumination, to name a few typical applications.

In many applications, it is desirable to arrange multiple LED light bricks in series so that the light bricks form a chain, row, or line of LED lights. However, securing the light bricks in this position may be difficult, particularly where the light bricks are used to illuminate an existing structure, such as a building, sign, monument, walkway, or other such structure. Unreliable attachment devices can cause the light bricks to become dislodged from their desired position, thus creating the appearance of holes or breaks in the lighting chain. When the light bricks are dislodged, the wires connecting the light bricks are sometimes damaged, causing a power disruption to the remaining light bricks. Previous attachment systems for light bricks are cumbersome to use, install, and adjust.

To address these problems, the present invention is directed to providing a simple, reliable solution to the problem of attaching standard LED light bricks to an existing structure.

### SUMMARY OF THE INVENTION

The LED light brick attachment device generally comprises a U-shaped channel and one or more generally J-shaped clips, the combination of which is capable of attaching a standard LED light brick to a support structure. The channel is defined by a base and two vertical sides, forming a trough capable of slideably seating a flange of a standard LED light brick. The clip is defined by a base, a first stem, and an elongated second stem, the base, first stem, and an elongated second stem forming a J-shaped cross-section having a trough. The top of the first stem has an inwardly protruding retaining lip. The second stem has an engagement means capable of engaging a fastener on the light brick. The trough of the clip is capable of being snugly disposed about the channel such that the retaining lip of the first vertical stem is snugly disposed above to the top of one of the vertical sides of the channel, which prevents the channel from being dislodged from the clip.

The ends of the light brick comprise a means for retaining a fastener. In the most common embodiment, the light bricks have an I-shaped cross-section, and the LED lights are retained in the web, which is disposed between a top flange and a bottom flange. To secure the light bricks to a structure or other support, the bottom flange is seated inside the trough of the channel. The clips can then be fitted over the channel such that the lip of the first stem is snugly disposed over the tip of one of the vertical walls of the channel, and the entire channel is snugly seated into the trough of the clip. The threaded fastener can then be installed into the retaining means and fitted to the engagement means, thereby securing the light brick inside the channel. The light bricks are connected to each other by wires that run along the trough of the channel.

In one embodiment, the second vertical stem further comprises an offset that shifts an upper portion of the second stem toward the trough of the clip. The offset forms an indented surface, or shoulder, capable of retaining one of the vertical sides of the channel, which further prevents the channel from being inadvertently dislodged from the J-shaped clip. In another embodiment, the attachment device additionally comprises a retaining clip capable of fitting over the first stem and vertical side of the channel, which prevents undesired slippage between the light brick and the channel. The channel can further comprise a means for anchoring the channel to a structural support, where such anchoring means could be threaded fasteners, brackets, glue, epoxy, clips, hangars, or the like.

### BRIEF DESCRIPTION OF THE DRAWINGS

FIG. 1 is an exploded view of the channel and the J-shaped clip.

FIG. 2 is a cross section of the channel seated in the trough of the J-shaped clip.

FIG. 3 is a perspective view of the LED light brick retained within the channel via one J-shaped clip.

FIG. 4 is a side view of the LED light brick retained within the channel via one J-shaped clip:

### DETAILED DESCRIPTION OF THE INVENTION

With reference to the drawings, the invention will now be described with regard for the best mode and the preferred embodiment. In general, the invention comprises an attachment device for retaining or mounting standard LED light bricks to signs, walls, or other support structures. The embodiments disclosed herein are meant for illustration and not limitation of the device. An ordinary practitioner will understand that it is possible to create other variations of the following embodiments without undue experimentation.

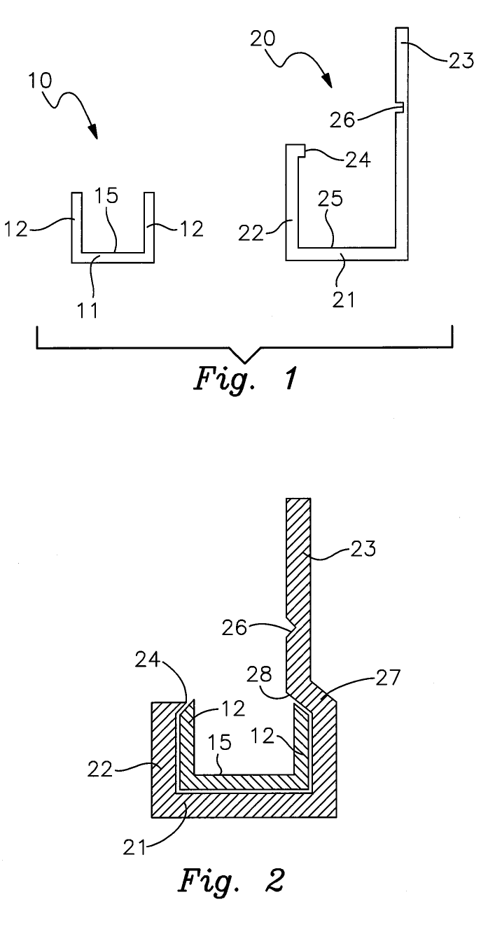

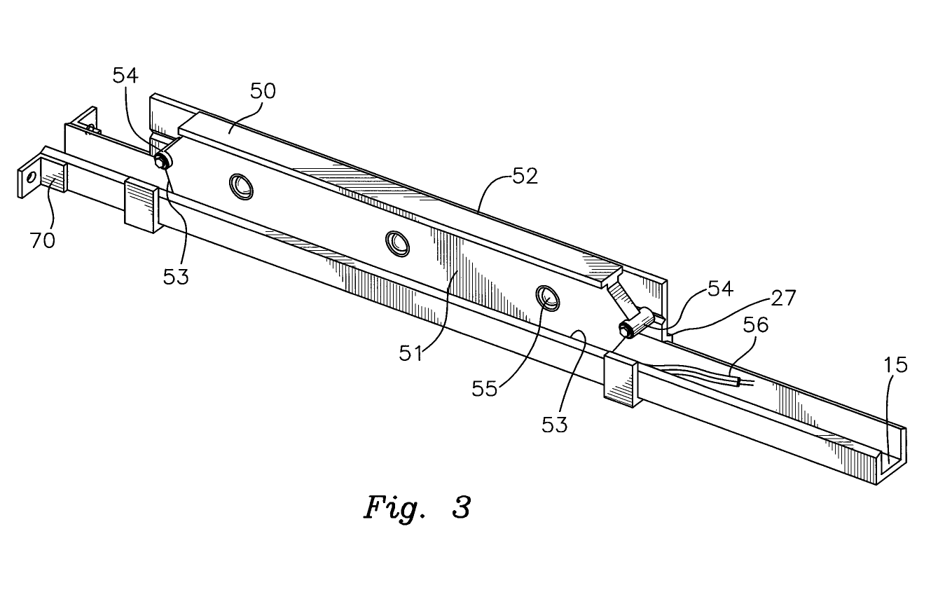

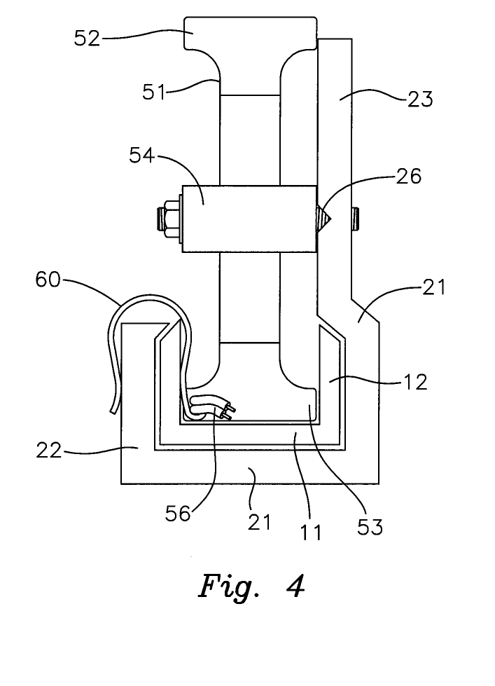

Referring to FIGS. 1 and 2, the attachment device generally comprises a U-shaped channel 10 and one or more generally J-shaped clips 20, the combination of which is capable of attaching a standard LED light brick 50 (shown in FIGS. 3 and 4) to a wall, sign, or other support structure. The channel 10 and clip 20 can be made of a variety of plastics, metals, alloys, or like material. These components can be made by extrusion or cold forming as appropriate. The channel 10 is defined by a base 11 and two vertical sides 12, wherein the channel 10 has an inner trough 15 capable of slideably seating a flange 53 of a LED light brick 50, as described below. The clip 20 is defined by a base 21, a first stem 22, and an elongated second stem 23, the base 21, first stem 22, and an elongated second stem 23 forming a J-shaped cross-section having a trough 25. The top of the first stem 22 has an inwardly protruding retaining lip 24. The second stem 23 has a means for engaging a fastener 26, such as an indent for receiving the tip of a threaded fastener, female threads capable of receiving the male threads of a threaded fastener, or a bored hole for receiving a cotter pin. The engagement means 26 could also be a groove or notch in the face of the second stem 23 such that the tip of a threaded fastener becomes seated into the groove or notch when the fastener is tightened. A combination of these or similar structures could be used to collectively provide an engagement means 26 for the fastener. The trough 25 of the clip 20 is capable of being snugly disposed about the channel 10 such that the retaining lip 24 of the first vertical stem 22 is snugly disposed above to the top of one of the vertical sides 12 of the channel 10, which prevents the channel 10 from being dislodged from the clip 20.

Referring to FIGS. 3 and 4, the light bricks 50, many of which are standard in the industry, typically have either a rectangular or an I-shaped cross section. The light bricks 50 can be connected in series by wires 56 carrying the required electric current to the LED lights 55. The ends of the light brick 50 comprise a means for retaining a fastener 54. This retaining means 54 could be a protrusion having threads for receiving a threaded fastener, or a bored hole to accommodate a smooth fastener such as a cotter pin, or any other such suitable structure. In the most common embodiment, the light bricks 50 have an I-shaped cross-section, and the LED lights 55 are retained in the web 51, which is disposed between a top flange 52 and a bottom flange 53. To secure the light bricks 50 to a structure or other support, the bottom flange 53 is seated inside the trough 15 of the channel 10. The clips 20 can then be fitted over the channel 10 such that the lip 24 of the first stem 22 is snugly disposed over the tip of one of the vertical walls 12 of the channel 10, and the entire channel 10 is snugly seated into the trough 25 of the clip 20. The clips 20 can be slid along the channel 10 and positioned adjacent to the light bricks 50 such that the engagement means 26 of each clip 20 is aligned with a retaining means 54 of a light brick 50. The threaded fastener can then be installed into the retaining means 54 and fitted to the engagement means 26, thereby securing the light brick 50 inside the channel 10. The light bricks 50 are connected to each other by wires 56 that run along the trough 15 of the channel 10, where the wires 55 are selected as appropriate to carry the electrical current needed to power the LED lights.

In one embodiment, the second vertical stem 23 further comprises an offset 27 that shifts an upper portion of the second stem 23 toward the trough 25 of the clip 20. The dimension of the offset 27 can be apportioned such that upper portion of the second stem 23 is disposed in close proximity to the retaining means 54 of the LED light brick 50 when the brick 50 is seated in the trough 15 of the channel 10. The proximity of the second stem 23 and the retaining means 54 can be adjusted as desired for the particular application and arrangement of attachment devices, means, and methods. For example, for use with threaded fasteners, it may be desirable to place the retaining means 54 in direct contact with the second stem 23. In other embodiments, a more loose fitting between the retaining means 54 and second stem 23 may be appropriate.

The offset 27 forms an indented surface, or shoulder 28, which can be position to fit snugly above the tip of the vertical side 12 of the channel 10 that is opposite that of the retaining lip 24 in the first stem 22 of the clip 20. Thus, the retaining lip 24 and the shoulder 28 retain the two vertical sides 12 of the channel 10, which prevents the channel from being inadvertently dislodged from the trough 25 of the J-shaped clip 20.

In another embodiment, the attachment device additionally comprises a retaining clip 60 capable of fitting over the first stem 22 and vertical side 12 of the channel 10. The clip 60 is adjusted to apply an amount of pressure between the channel 10 and clip 20 adequate to prevent undesired slippage between the light brick 50 and the channel 10. The channel 10 can further comprise a means for anchoring the channel to a structural support 70, where such anchoring means 70 could be threaded fasteners, brackets, glue, epoxy, clips, hangars, or the like.

The embodiments disclosed above are merely representative of the invention and are not meant for limitation thereof. For example, an ordinary practitioner would understand that there are several commercially available LED light bricks 50 that could be substituted for the shapes exemplified above, and some of the features and components of the attachment device may require adaptation. In addition, several embodiments described above incorporate elements that are interchangeable with the features of other embodiments. It is understood that equivalents and substitutions for certain elements and components set forth above may be obvious to those having ordinary skill in the art, and therefore the true scope and definition of the invention is to be as set forth in the following claims.

We claim:

1. A LED light brick attachment device comprising:
a U-shaped channel defined by a base and two vertical sides, wherein the channel has a trough capable of slideably seating a flange of a LED light brick; and
a J-shaped clip defined by a base, a first stem, and a second stem, wherein the first stem has an inwardly protruding retaining lip disposed at the top of the first stem, the second stem having an engagement means for engaging a fastener, and wherein the trough of the J-shaped clip is capable of being snugly disposed about the channel such that the retaining lip of the first stem is disposed above to the top of a vertical side of the channel in a manner preventing the channel from being dislodged from the clip.

2. The LED light brick attachment device of claim 1, wherein the second stem further comprises an offset that shifts an upper portion of the second stem toward the trough of the clip such that the upper portion of the second stem is capable of being disposed in close proximity to a LED light brick seated in the trough of the channel.

3. The LED light brick attachment device of claim 2, wherein the offset forms a shoulder capable of being disposed about the top of the vertical side of the channel that is opposite the vertical side retained by the retaining lip.

4. The LED light brick attachment device of claim 3, wherein the engagement means is a notch in the second stem.

5. The LED light brick attachment device of claim 3, wherein the engagement means is a groove in the second stem.

6. The LED light brick attachment device of claim 3, wherein the engagement means is threaded hole in the second stem.

7. The LED light brick attachment device of claim 3, wherein the tips of the vertical sides of the channel, the retaining lip, and the shoulder are beveled to create an inclined mating surface between the retaining lip and a vertical side, and between the shoulder and opposite vertical side.

8. The LED light brick attachment device of claim 1, wherein a retaining clip is secured over the first stem and a vertical side of the channel, said retaining clip capable of preventing the J-shaped clip from sliding along the channel.
